(19) United States
(12) Patent Application Publication
(10) Pub. No.: US 2010/0195349 A1
(43) Pub. Date: Aug. 5, 2010

(54) Light Source of Varying Thickness

(75) Inventors: Udayan Kanade, Pune (IN); Gaurav Kulkarni, Pune (IN); Karthikk Sridharan, Minneapolis, MN (US); Manas Alekar, Irvine, CA (US); Manohar Joshi, Los Angeles, CA (US); Sanat Ganu, Pune (IN); Balaji Ganapathy, Atlanta, GA (US)

Correspondence Address: Cowsy J. Wadia, 776 Coronado Lane, Foster City, CA, 94404, US

(73) Assignee: I2IC CORPORATION, Foster City, CA (US)

(21) Appl. No.: 12/667,525

(22) PCT Filed: Jul. 5, 2008
(86) PCT No.: PCT/IB08/52705

§ 371 Date: Jan. 1, 2010

(30) Foreign Application Priority Data
Jul. 5, 2007 (IN) 1085/MUM/2007

(51) Int. Cl. F21V 7/04; B29C 65/48; B29D 11/00

(52) U.S. Cl. 362/607; 156/60; 156/196; 264/1.24; 362/608; 362/609; 362/613

(57) ABSTRACT

An apparatus and method for a light source are disclosed. The apparatus comprises a light guide including light extracting features and at least one light source placed near an end of the light guide. Light from the light source gets deflected by the light extracting features and emanates in a predetermined pattern along a surface of the light guide. The light guide has different thicknesses in different parts.

The present patent claims priority from provisional patent number 1285/MUM/2007 titled “Light Source in the Form of a Sheet” filed in Mumbai, India on the 5 of Jul. 2007.

### TECHNICAL FIELD

The present invention relates to an illumination system. Particularly, the invention relates to an apparatus and method for a light source of varying thickness.

### BACKGROUND ART

Illumination is used to light objects for seeing, as also for photography, microscopy, scientific purposes, entertainment productions (including theater, television and movies), projection of images and as backlights of displays. For illumination purposes, systems in the form of point or single dimensional sources of light are used. Such systems have many drawbacks: light intensity is very high at the light source compared to the rest of the room or environment, and thus such light sources are hurtful to the eye. Such sources also cast very sharp shadows of objects, which are not pleasing to the eye, and may not be preferred for applications such as photography and entertainment production. Such sources also cause glare on surfaces such as table tops, television front panels and monitor front panels.

There are systems that act as light sources in the form of a sheet. Fluorescent lights for home lighting may be covered by diffuser panels to reduce the glare. These systems are bulky. They are also not transparent. Diffusers and diffuse reflectors, such as umbrella reflectors, are used as light sources for photography and cinematography, but they are only approximations to uniform lighting.

Backlights of flat-panel screens such as LCD screens provide uniform or almost uniform light. One of the prior solutions for backlighting an LCD screen is to have a light guide in the form of a sheet, with some shapes such as dots or prisms printed on it to extract light or by dispersing light diffusing particles in the bulk. The light guide is formed by sandwiching a high refractive index material between two low refractive index materials. The light is guided from one or more ends of the sheet.

FIG. 1A illustrates a light source 199, according to a prior art. Light is extracted from light guide 104, by using light diffuser in the bulk.

FIG. 1B illustrates a light source 199 having light diffuser 102 in the bulk as seen from the front, according to a prior art. Light guide 104 contains light diffuser 102 dispersed in the bulk. The light diffuser includes a sparse concentration of light diffuser particles. The concentration of the light diffuser is varied as a function of the position so that a uniform emanation of light takes place from the surface when illuminated by primary light sources (not shown) placed near the ends. The concentration of light diffuser is such that the light guide 104 is primarily transparent when seen from the front. But, the total number of light diffuser particles at a cross-section away from the primary light sources is larger than the number of light diffuser particles near the primary light sources. Thus, the light source 199 is more transparent near the primary light sources and less transparent away from them. Transparent light sources are utilized in applications such as high efficiency polarized light sources, high efficiency collimated light sources, high efficiency linear light sources that couple into sheet light sources, high efficiency transflective displays, high efficiency multicolored light sources, etc. Thus, the loss of transparency near the center of light source 199 is a problem. The light guide could be made thinner to improve transparency, but it is harder to couple light into a thinner light guide. Thus, there is a need for a light source that is more transparent than the ones available in present art.

There is also a need for making a light source using lesser material for the light guide than is possible in the present art. Using lesser material reduces cost, and reduces the environmental impact. The light guide could be made thinner to reduce the material used, but it is harder to couple light into a thinner light guide.

FIG. 1C illustrates a light source 199 having light diffuser 102 in the bulk as seen from the side, according to a prior art. Light guide 104 contains light diffuser 102 dispersed in the bulk.

Light may also be extracted using Fresnel reflection from interfaces between sheets of different refractive indexes, as described below.

FIG. 2A illustrates an exemplary light source 299. The light source 299 comprises a light guide 204. The light guide 204 comprises transparent sheets such as transparent sheet 202 and transparent sheet 203, having different refractive indexes. The transparent sheets make a particular angle with the side of light guide 204. Any light ray generated by a primary light source (not shown) traverses the light guide 204. At each interface between the slanted transparent sheets such as the interface between sheets 202 and 203, the light ray is partially reflected out of the light guide 204 and is partially refracted into the next sheet. Reflected light rays emanate out of light guide 204. By varying the refractive indexes, slopes and thicknesses of the individual sheets, the emanated light rays form a predetermined light emanation pattern. Similar to the case of light guide with light diffuser particles, the light source 299 producing uniform illumination is more transparent closer to the primary light sources and less transparent away from them.

FIG. 2B illustrates an exemplary light source 299 as viewed from the front. The light source 299 comprises a light guide 204. The light guide 204 comprises transparent sheets such as transparent sheet 202 and transparent sheet 203, having different refractive indexes.

FIG. 2C illustrates an exemplary light source 299 as viewed from the side. The light source 299 comprises a light guide 204. The light guide 204 comprises transparent sheets such as transparent sheet 202 and transparent sheet 203, having different refractive indexes and make a particular angle with the side of light guide 204.

### DISCLOSURE OF INVENTION

### Summary

An apparatus and method for a light source are disclosed. The apparatus comprises a light guide including light extracting features and at least one light source placed near an end of the light guide. Light from the light source gets deflected by the light extracting features and emanates in a predetermined pattern along a surface of the light guide. The light guide has different thicknesses in different parts.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1A illustrates a light source, according to a prior art.

FIG. 1B illustrates a light source having light diffuser in the bulk as seen from the front, according to a prior art.

FIG. 1C illustrates a light source having light diffuser in the bulk as seen from the side, according to a prior art.

FIG. 2A illustrates an exemplary light source.

FIG. 2B illustrates an exemplary light source as viewed from the front.

FIG. 2C illustrates an exemplary light source as viewed from the side.

FIG. 3 illustrates a light guide, according to one embodiment.

FIG. 4A illustrates a light guide, as seen from the front, according to one embodiment.

FIG. 4B illustrates a light guide, as seen from the side, according to one embodiment.

FIG. 5 illustrates a light guide, according to one embodiment.

FIG. 6 illustrates an exemplary element of a light guide, according to an embodiment.

FIG. 7 illustrates a light source, according to an embodiment.

FIG. 8 illustrates a mirrored light source, as seen from the side, according to one embodiment.

FIG. 9 illustrates a light source, as seen from the side, according to one embodiment.

FIG. 10 is a flow diagram illustrating an exemplary process of manufacturing a light guide with varying thickness, according to one embodiment.

FIG. 11A illustrates a pair of sheets, according to one embodiment.

FIG. 11B illustrates a curved pair of sheets, according to one embodiment.

FIG. 11C illustrates a composite sheet, according to one embodiment.

FIG. 11D illustrates a light guide, according to one embodiment.

FIG. 12 is a flow diagram illustrating an exemplary process of manufacturing a light guide with varying thickness, according to one embodiment.

FIG. 13A illustrates an apparatus comprising container and curved object, according to one embodiment.

FIG. 13B illustrates an apparatus comprising container, curved object and liquid, according to one embodiment.

FIG. 13C illustrates an apparatus comprising container and sheet with required particle concentration profile, according to one embodiment.

FIG. 13D illustrates a light guide, according to one embodiment.

FIG. 14 illustrates a light source, according to one embodiment.

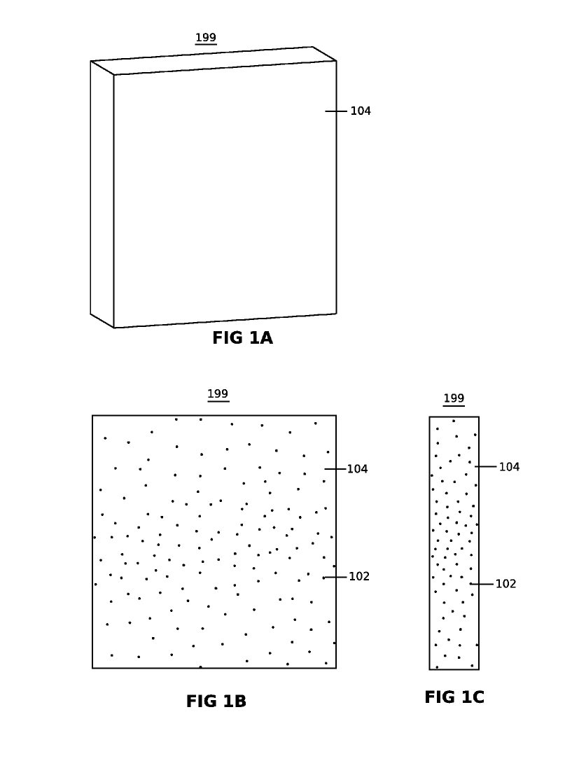

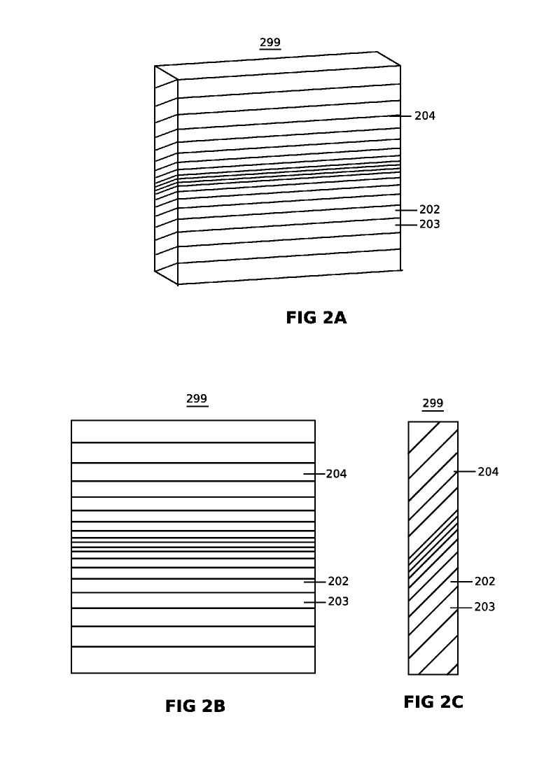

### DETAILED DESCRIPTION

An apparatus and method for a light source are disclosed. The apparatus comprises a light guide including light extracting features and at least one light source placed near an end of the light guide. Light from the light source gets deflected by the light extracting features and emanates in a predetermined pattern along a surface of the light guide. The light guide has different thicknesses in different parts.

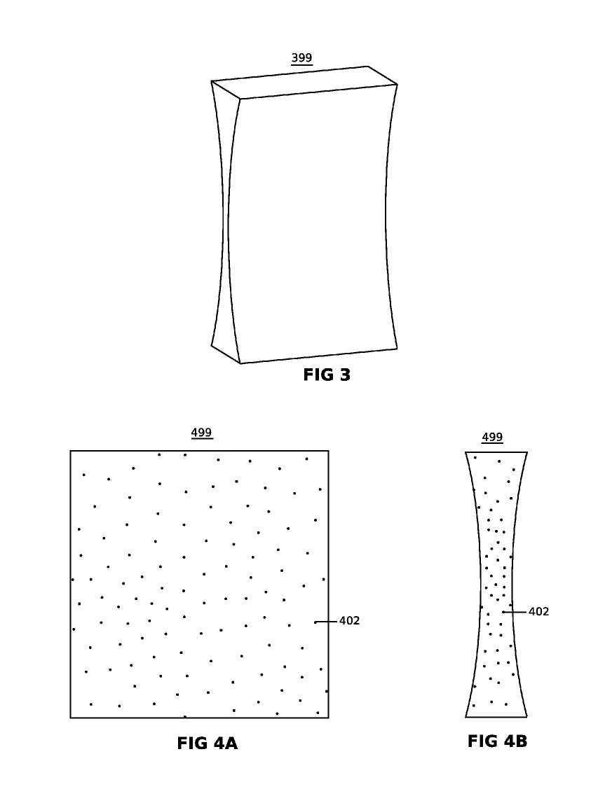

FIG. 3 illustrates a light guide 399, according to one embodiment. The light guide 399 is made up of a transparent material. The light guide 399 has different thicknesses in different parts.

Primary light sources (not shown) couple light into the light guide 399 from its ends. The coupled light traverses the light guide 399, and gets extracted by light extraction features present in the light guide. In an embodiment, light extraction features comprise light diffuser. A light diffuser comprises light dispersing particles such as metallic, organic or other powder or pigment, transparent particle, transparent bubble, etc. which deflect light by refraction, reflection and scattering. In another embodiment, light extraction features comprise slanted transparent layers of various refractive indexes. In other embodiments, light extraction features comprise extraction features such as prisms, shapes, microlenses or etching on the surface of the light guide 399.

In an embodiment, light extraction features are present at a higher density at locations away from the primary light sources than at locations close to the primary light sources. To compensate for the loss of transparency to external light that would otherwise occur, the light guide 399 is thinner at places where higher density of light extraction features is used. This gives more transparency over the entire light guide 399. Since a lower density of light extraction features are used close to the primary light sources, the light guide 399 can be made thicker close to the primary light sources, thus making it possible to couple the light from the primary light sources efficiently into the light guide 399.

The light guide 399, being thinner in parts than the maximum thickness, may also be made using lesser material than traditional light guides of light sources, thus saving costs and reducing environmental impact.

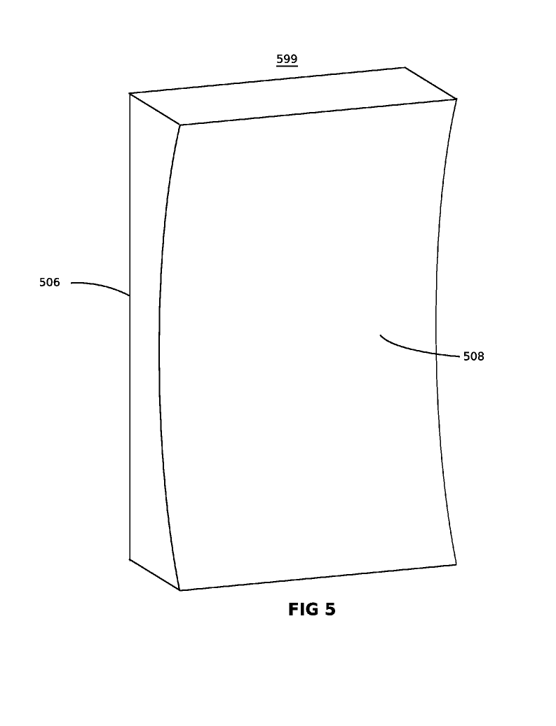

FIG. 4A illustrates a light guide 499, as seen from the front, according to one embodiment. Light guide 499 is made up of a transparent material. Light guide 499 contains light diffuser 402 dispersed in the bulk. The concentration of the light diffuser 402 is varied over the light guide 499 so that light emanates from the light guide in a predetermined pattern, when illuminated by one or more linear sources of light placed near one or more ends of light guide 499. The light diffuser comprises light dispersing particles such as metallic, organic or other powder or pigment, transparent particle, transparent bubble, etc. which deflect light by refraction, reflection and scattering. In an embodiment, the concentration of light diffuser 402 is sparse so that the light guide is primarily transparent when seen from the front.

In an alternate embodiment, light extracting features other than light diffuser, such as slanted transparent layers of various refractive indices or shapes or etchings on the surface are used.

FIG. 4B illustrates a light guide 499, as seen from the side, according to one embodiment. Light guide 499 is made up of a transparent material. Light guide 499 contains light diffuser 402 dispersed in the bulk. The thickness of the light guide 499 is different in different parts of the light guide 499. The thickness of the light guide 499 is lesser in a part having more concentration of light diffuser 402, than the thickness of a part having less concentration of light diffuser particles. In an embodiment, the product of the thickness of the light guide 499 in a part of the light guide 499 and the concentration of light diffuser 402 in that part is kept lower than a predefined constant. This product is approximately proportional to the opacity of the light guide 499 to light traveling across it, i.e. to light entering one face and exiting another face. Keeping this product lower than a certain predefined constant allows the opacity to be lower than another constant. In a particular embodiment, the thickness is inversely proportional to the concentration of light diffuser along that cross-section.

FIG. 5 illustrates a light guide 599, according to one embodiment. The light guide 599 is made up of a transparent material. It has a curved face 508 and flat face 506. Thus, the light guide 599 has different thicknesses in different parts. In another embodiment, both the faces 508 and face 506 are curved.

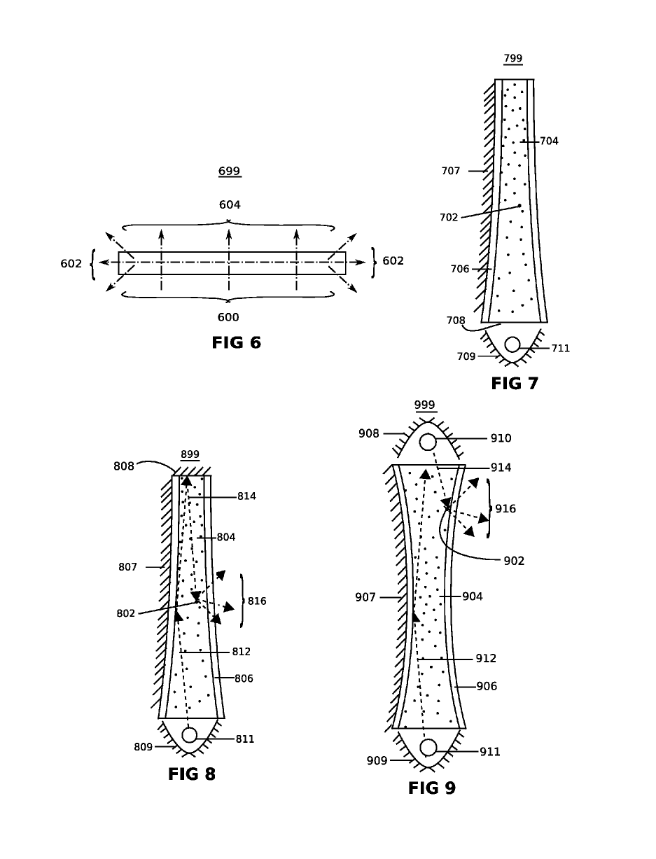

FIG. 6 illustrates an exemplary element 699 of a light guide, according to an embodiment. Light guide element 699 has the thickness and breadth of the light guide but has a very small height. Light 600 enters element 699. Some of the light gets dispersed and leaves the light guide as illumination light 602, and the remaining light 604 travels on to the next light guide element. The power of the light 600 going in is matched by the sum of the powers of the dispersed light 602 and the light 604 continuing to the next light guide element. The ratio of the fraction of light dispersed 602 with respect to the light 600 entering the element 699, to the height of element 699 is the volume extinction coefficient of element 699. As the height of element 699 decreases, the volume extinction coefficient approaches a constant. This volume extinction coefficient of element 699 bears a certain relationship to the density of light extracting features at the element 699. The relationship may be approximated in an embodiment as a linear relationship, i.e. a direct proportion. In an embodiment, light extracting features comprise light diffuser, and the density of light extracting feature is the concentration of the light diffuser particles. In another embodiment, light extracting features comprise layers of transparent material of different refractive indexes, and the density of light extracting features is the spatial frequency of the layers. In the case of the transparent layers, the volume extinction coefficient also depends upon the reflectivity of the interface between the two layers. The relationship between the volume extinction coefficient and the density of light extracting features permits evaluation of the volume extinction co-efficient of element 699 from the density of light extracting features at the element 699, and vice versa. Thus, given a particular setting of light extracting features, the volume extraction coefficients at various light guide elements can be evaluated, which can be used to find out the pattern of emanated light. Conversely, knowing the pattern of light to be emanated, the volume extinction coefficient required at various light guide elements can be calculated and used to design the density and other parameters of light extracting features.

As the height of element 699 is reduced, power in the emanating light 602 reduces proportionately. The ratio of power of the emanating light 602 to the height of element 699, which approaches a constant as the height of the element is reduced, is the emanated linear irradiance at element 699. The emanated linear irradiance at element 699 is the volume extinction coefficient times the power of the incoming light (i.e. power of light traveling through the element). The gradient of the power of light traveling through the element 699 is the negative of the emanated linear irradiance. These two relations give a differential equation. This equation can be represented in the form “dP/dh=−qP=−K” where:

h is the distance of a light guide element from that end of the light guide near which the primary light source is placed;

P is the power of the light being guided through that element;

q is the volume extinction coefficient of the element; and

K is the emanated linear irradiance at that element.

This equation is used to find the emanated linear irradiance given the volume extinction coefficient at each element. This equation is also used to find the volume extinction coefficient of each element, given the emanated linear irradiance. To design a particular light source with a particular emanated linear irradiance, the above differential equation is solved to determine the volume extinction coefficient at each element of the light source. From this, the density of light extraction features at each light guide element of the light guide is determined. Such a light guide is used to give a light source of a required emanated linear irradiance pattern.

FIG. 7 illustrates a light source 799, according to an embodiment. A light source 711 is placed at one end of the light guide 704. In an embodiment, a reflecting surface 709 couples light from the light source 711 into the light guide 704. In an embodiment, reflecting surface 709 couples light exiting the light guide 704 back into the light guide 704. In an embodiment the reflecting surface 709 is parabolic in shape or a parabolic cylinder, and the light source 711 is placed at its focus. Reflecting surface 709 and optional mirror 707 may be any well known means of reflecting light, including metallic surfaces, distributed Bragg reflectors, hybrid reflectors, total internal reflectors or omni-directional reflectors. Optional cladding 706 has lower refractive index than light guide 704. Cladding 706 can be made of any material or may comprise of air or vacuum.

In an embodiment, the mirror 707 reflects a part of the light exiting the light guide, such that all light emanates from one surface of the light guide 704. In an embodiment, the minor 707 is curved in conformance with the curvature of the light guide 704. In another embodiment, the minor behind the light guide is not curved, and may be a planar mirror. In yet another embodiment, the minor is made of a shape so as to correct the distortion in the shape of the image of light guide 704 in the minor when viewed through light guide 704. In an embodiment, the mirror is made of a shape such that the mirror and the light guide 704 together optically simulate an approximately distortion free plane minor.

If a uniform density of light extraction features is used in the light guide 799, the emanated linear irradiance drops exponentially with height. Uniform emanated linear irradiance may be approximated by choosing a density of light extraction features such that the power drop from the end near the light source to the opposite end is minimized. In an embodiment, to reduce the power loss and also improve the uniformity of the emanated power, opposite end reflects light back into the light guide. In an alternate embodiment, another light source sources light into the opposite end.

To achieve uniform illumination, the volume extinction coefficient and hence the density of light extraction features has to be varied over the length of the light guide 799. The density of light extraction features 702 is varied from sparse to dense from the light source end 708 of light guide 704 to the opposite end. In an embodiment, the volume extinction coefficient is q=K/(A−hK), where A is the power going into the light guide 799 and K is the emanated linear irradiance at each light guide element, a constant number for uniform illumination. If the total height of the light source is H, then H times K should be less than A, i.e. total power emanated should be less than total power going into the light guide, in which case the above solution is feasible. If the complete power going into the light guide is utilized for illumination, then H times K equals A. In an embodiment, H times K is kept only slightly less than A, so that only a little power is wasted, as well as volume extinction coefficient is always finite. In an embodiment, the thickness of the light guide is varied in proportion to the inverse of the volume extinction coefficient.

The same pattern of emanation will be sustained even if the power of light emanated from light source 711 changes. For example, if the light source 711 provides half the rated power, each element of the light guide 704 will emanate half its rated power. A light guide that is designed to act as a uniform light source, acts as a uniform light source at all power ratings by changing the power of its light source or sources. If there are two light sources, their powers are changed in tandem to achieve this effect.

FIG. 8 illustrates a mirrored light source 899, as seen from the side, according to one embodiment. Light guide 804 of a transparent material, has a sparse distribution of light extracting features 802 in it. Light guide 804 has higher refractive index than optional cladding 806. Optional cladding 806 can be made of any material or may comprise air or vacuum. The light guide 804 has different thicknesses in different parts, and has a lesser thickness in a part having more density of light extracting features, than it has in a part having a lesser density of light extracting features. Light source 811 is placed at one end of the light guide 804. In an embodiment, the reflecting surface 809 couples light from the light source 811 into the light guide 804. In an embodiment, reflecting surface 809 couples light exiting the light guide 804 back into the light guide 804. In an embodiment, the reflecting surface 809 is parabolic in shape or a parabolic cylinder, and the light source 811 is placed at its focus. The other end of the light guide 804 is a mirrored end 808, such that it will reflect light back into the light guide 804. By using a minor at the mirrored end 808, high variations in density of light extracting features 802 in the light guide 804 is not necessary. Reflecting surface 809, optional mirror 807 and mirror 808 may be any well known means of reflecting light, including metallic surfaces, distributed Bragg reflectors, hybrid reflectors, total internal reflectors or omni-directional reflectors. Light 812 is guided inside the light guide by reflection or total internal reflection. The light 814 inside the light guide 804 gets deflected due to the light extracting feature 802 and escapes out of the light guide in the form of emanated light 816.

In an embodiment, the mirror 807 reflects a part of the light exiting the light guide, such that all light emanates from one surface of the light guide. In an embodiment, the mirror 807 is curved in conformance with the curvature of the light guide 804. In another embodiment, the minor behind the light guide is not curved, and may be a planar mirror. In yet another embodiment, the minor is made of a shape so as to correct the distortion in the shape of the image of light guide 804 in the minor when viewed through light guide 804. In an embodiment, the mirror is made of a shape such that the mirror and the light guide 804 together optically simulate an approximately distortion free plane minor.

The volume extinction coefficient to achieve uniform illumination in light source 899 is:

q=1/sqrt ((h−H)̂2+D/K̂2)

where

D=4A(A−HK).

FIG. 9 illustrates a light source 999, as seen from the side, according to one embodiment. Light guide 904 of a transparent material, has a sparse distribution of light extracting features 902 in it. Light guide 904 has higher refractive index than optional cladding 906. Optional cladding 906 can be made of any material or may comprise air or vacuum. Light source 910 and 911 are placed at opposite ends of the light guide 904. In an embodiment, reflecting surfaces 908 and 909 couple light from the light source 910 and 911 respectively into the light guide 904. In an embodiment, reflecting surfaces 908 and 909 couple light exiting the light guide 904 back into the light guide 904. In an embodiment, the reflecting surfaces 908 and 909 are parabolic in shape or parabolic cylinders, and the light sources 910 and 911 are placed at their respective focuses. Reflecting surfaces 908 and 909, and optional mirror 907 may be any well known means of reflecting light, including metallic surfaces, distributed Bragg reflectors, hybrid reflectors, total internal reflectors or omni-directional reflectors. Light 912 is guided inside the light guide by reflection or total internal reflection. The light 914 inside the light guide 904 gets deflected due to the light extracting feature 902 and escapes out of the light guide in the form of emanated light 916.

In an embodiment, the mirror 907 reflects a part of the light exiting the light guide, such that all light emanates from one surface of the light guide. In an embodiment, the mirror 907 is curved in conformance with the curvature of the light guide 904. In another embodiment, the minor behind the light guide is not curved, and may be a planar mirror. In yet another embodiment, the minor is made of a shape so as to correct the distortion in the shape of the image of light guide 904 in the minor when viewed through light guide 904. In an embodiment, the mirror is made of a shape such that the mirror and the light guide 904 together optically simulate an approximately distortion free plane minor.

By using two light sources 910 and 911, high variations in density of light extracting features 902 in the light guide is not necessary. The differential equation provided above in conjunction with FIG. 6 is used independently for deriving the emanated linear irradiance due to each of the light sources 910 and 911. The addition of these two emanated linear irradiances provides the total emanated linear irradiance at a particular light guide element.

Uniform illumination for light source 999 is achieved by volume extinction co-efficient q=1/sqrt ((h−H/2)̂2+C/K̂2) where sqrt is the square root function, ̂ stands for exponentiation, K is the average emanated linear irradiance per light source (numerically equal to half the total emanated linear irradiance at each element) and C=A (A−HK).

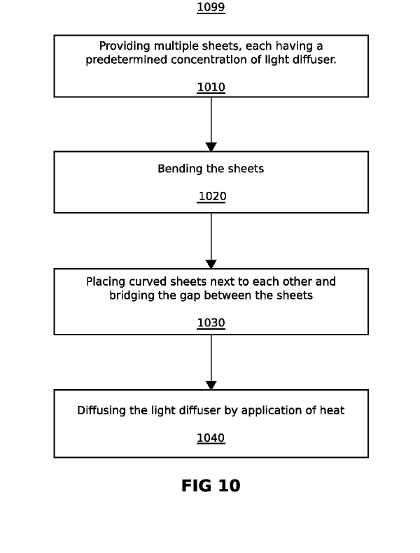

FIG. 10 is a flow diagram illustrating an exemplary process 1099 of manufacturing a light guide with varying thickness, according to one embodiment. A number of sheets are provided where each sheet has a predetermined concentration of light diffuser.(1010) These sheets are bent by heating, casting, stamping, etc. to give curved sheets having light diffuser.(1020) In an alternate embodiment, curved sheets having light diffuser may be manufactured by other means such as casting or injection molding in a curved mold, polymerization in a curved mold, blowing, etc. Curved sheets are placed next to each other and the space between the sheets is bridged using transparent material, transparent glue, by polymerization or by using the same material as the curved sheets to give a composite sheet.(1030) In an embodiment, the sheets are made of a transparent polymer, the space between sheets is filled by a pre-polymerized solution of the same material, and the polymerization reaction is completed to give composite sheet. In an optional step, light diffuser inside composite sheet diffuses into the thickness by application of heat.(1040)

In an embodiment, the material comprising the bridge between curved sheets does not include a light diffuser, at least one of the curved sheets has at least one surface having the same shape as one surface of the final light guide, and the light guide hence formed has a varying concentration of light diffuser and a varying thickness that varies inversely proportional to the concentration of the light diffuser.

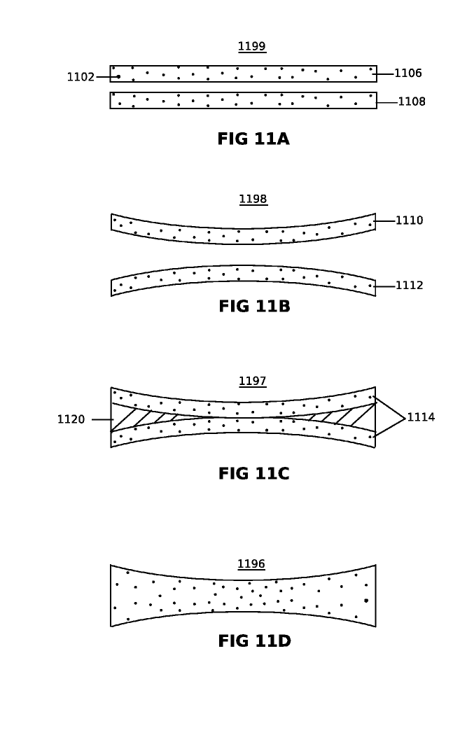

FIG. 11A illustrates a pair of sheets 1199, according to one embodiment. Sheet 1106 and sheet 1108 are made up of a transparent material and have light diffuser 1102 dispersed in them. In an embodiment, the light diffuser is uniformly dispersed throughout the bulk of sheet 1106 and sheet 1108.

FIG. 11B illustrates a curved pair of sheets 1198, according to one embodiment. A pair of transparent sheets with light diffuser dispersed in them are curved to give sheet 1110 and sheet 1112. In an embodiment, the pair of sheets are heated and are bent to give sheets 1110 and 1112. In another embodiment, the pair of sheets are cast in the shape of sheets 1110 and 1112 directly. In an embodiment only one of the sheets is bent.

FIG. 11C illustrates a composite sheet 1197, according to one embodiment. A pair of curved sheets 1114 with light diffuser dispersed in them is joined together to give a composite sheet 1197. Bridge 1120 fills up the gap between pair of curved sheets 1114. In an embodiment, the bridge 1120 is of the same material as the pair of sheets 1114. In another embodiment, the bridge 1120 is a transparent glue. In an embodiment, the pair of curved sheets 1114 is made of a transparent polymer, the space between pair of sheets 1114 is filled by a pre-polymerized solution of the same material, and the polymerization reaction is completed to give composite sheet 1197. In an embodiment, the composite sheet 1197 becomes the light guide of the light source of the present invention.

FIG. 11D illustrates a light guide 1196, according to one embodiment. Light diffuser inside a composite sheet comprising curved sheets and bridge diffuses throughout the thickness of the composite sheet to give a light guide 1196 of varying thickness including light diffuser. In an embodiment, the composite sheet is heated, and the light diffuser diffuses through the liquid or viscous composite sheet to give light guide 1196.

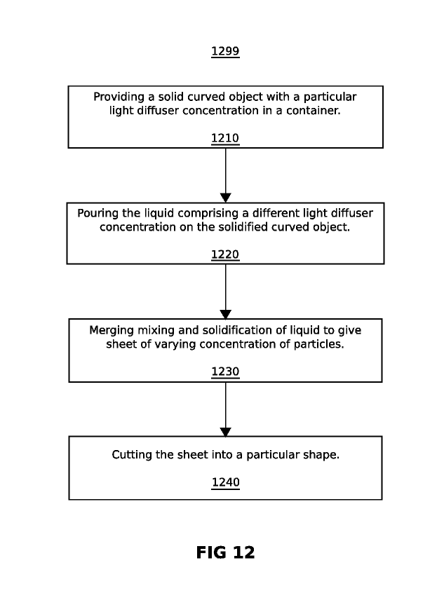

FIG. 12 is a flow diagram illustrating an exemplary process 1299 of manufacturing a light guide with varying thickness, according to one embodiment. A curved object having a particular concentration of light diffuser is inserted in a container.(1210) The curved object may be manufactured by processes such as casting, injection molding, mold polymerization, machining, etc. Processes such as casting, injection molding and mold polymerization may be performed in the container itself, so that the formed curved object is already present in the container. A liquid having a particular particle concentration is poured onto the curved object (1220). The liquid merges and mixes with the curved object, and eventually solidifies to give a sheet with a required light diffuser concentration profile.(1230) In an embodiment, the curved object diffuses into the liquid before complete solidification of the liquid. Solidification is achieved by cooling the liquid, or by polymerization, or by other physical or chemical means. The solidification process uses a controlled temperature or polymerization schedule, or other process such that the rate of physical diffusion of the solid in the liquid is controlled as a function of time. Optionally, during solidification, the light diffuser undergoes migration due to physical diffusion and in alternate embodiments, due to buoyant force, convection, non-uniform diffusion rates, and other forces. Solidified sheet is cut into a predetermined shape to give light guide with varying thickness.(1240)

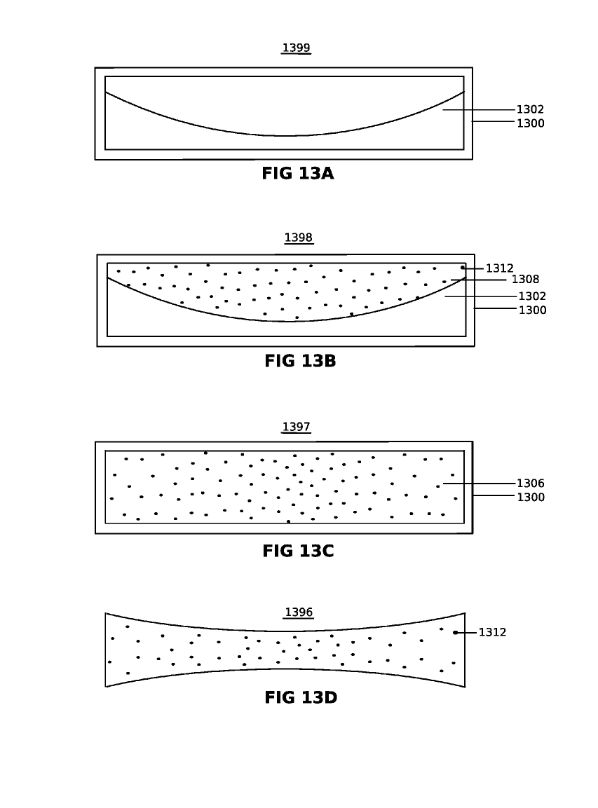

FIG. 13A illustrates an apparatus 1399 comprising container 1300 and curved object 1302, according to one embodiment. A curved object 1302 having a particular concentration of light diffuser particles is inserted in a container 1300. The shape of curved object 1302 is designed for a required particle concentration profile at the end of the manufacturing process. The curved object 1302 along with the container 1300 now acts as a cast in the manufacturing process.

FIG. 13B illustrates an apparatus 1398 comprising container 1300, curved object 1302 and liquid 1308, according to one embodiment. A liquid 1308 with a light diffuser 1312 of a particular concentration is poured in the cast formed by container 1300 and curved object 1302. The concentration of particles in liquid 1308 is different than the concentration of particles in curved object 1302.

FIG. 13C illustrates an apparatus 1397 comprising container 1300 and sheet 1306 with required particle concentration profile, according to one embodiment. Liquid poured in a container containing a curved object solidifies to produce a sheet 1306 having the required particle concentration profile. In an embodiment, the solidification is done by polymerization or by cooling of the liquid. In one embodiment, the liquid is a plastic monomer which is then polymerized.

According to an embodiment, the curved object and the liquid in the container diffuse into each other before complete solidification of the liquid. The diffusion may be caused by the curved object partially or completely dissolving in liquid. The liquid may be heated to cause this dissolution.

FIG. 13D illustrates a light guide 1396, according to one embodiment. A sheet having a particular concentration profile of light diffusers is cut into a predetermined shape to give light guide 1396 with light diffuser 1312 disposed in a predetermined concentration profile.

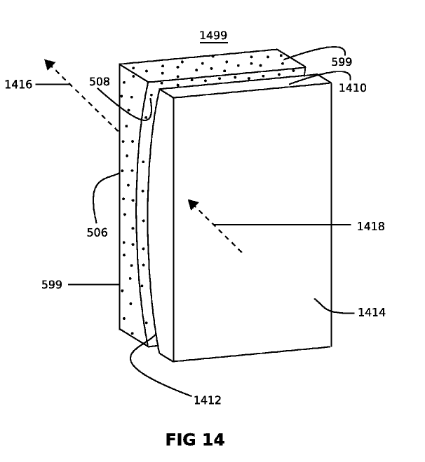

FIG. 14 illustrates a light source 1499, according to one embodiment. The light guide 599 is made of a transparent material and includes light extracting features. It has a curved face 508 and flat face 506. Transparent sheet 1410 with at least one curved surface 1412 is provided adjacent to light guide 599. In an embodiment, the curved surface 1412 of the transparent sheet 1410 is placed adjacent to the curved face 508 of light guide 599. Light ray 1418 entering sheet 1410 from the flat face 1414 emerges from the flat face 506 of light guide 599 as ray 1416. Ray 1416 is in the same direction as the ray 1418. In an embodiment, both the faces of light guide 599 are curved, and another sheet like transparent sheet 1410 (not shown) is provided near the other curved face of light guide 599.

An apparatus and method for light source of varying thickness are disclosed. It is understood that the embodiments described herein are for the purpose of elucidation and should not be considered limiting the subject matter of the present patent. Various modifications, uses, substitutions, recombinations, improvements, methods of production without departing from the scope or spirit of the present invention would be evident to a person skilled in the art.

1. An apparatus comprising, a light guide and at least one light source placed near an end of the light guide, the light guide comprising transparent material and light extracting features, wherein the light guide has different thicknesses in different parts.

2. The apparatus of claim 1 wherein the light guide comprises a first position and a second position, wherein the first position is closer to the light source than the second position, the light guide is thicker at the first position than at the second position and the light extracting features are present at a lesser density in the first position than in the second position.

3. The apparatus of claim 1, wherein the light extracting features comprise a light diffuser.

4. The apparatus of claim 3, wherein the light diffuser comprises particles which reflect light.

5. The apparatus of claim 3, wherein the light diffuser comprises particles which refract light.

6. The apparatus of claim 3, wherein the light diffuser comprises particles which scatter light.

7. The apparatus of claim 1, wherein the light extracting features comprise layers of transparent material, at least two such layers having refractive indexes different from each other.

8. The apparatus of claim 1, further comprising a minor at the end of the light guide opposite to the end near which light source is placed.

9. The apparatus of claim 1, further comprising a second light source at the end of the light guide opposite to the end near which light source is placed.

10. The apparatus of claim 1, further comprising a minor placed near a face of the light guide.

11. The apparatus of claim 10, wherein the mirror is a curved mirror.

12. The apparatus of claim 1, further comprising a curved sheet placed near a face of the light guide.

13. The apparatus of claim 1 wherein the thickness of the light guide varies inversely to the density of light extracting features.

14. A method comprising bridging curved sheets using a bridge to give a light guide with varying thickness.

15. The method of claim 14, wherein at least one curved sheet comprises light extracting features.

16. The method of claim 14, wherein the bridge comprises a transparent material.

17. The method of claim 16, wherein the transparent material comprises a transparent glue.

18. The method of claim 14, wherein bridging the curved sheets comprises polymerization.

19. The method of claim 14, wherein the curved sheets are formed by bending.

20. The method of claim 14, further comprising diffusing the light extracting features into the light guide with varying thickness.

21. The method of claim 14, wherein at least one of the curved sheets has at least one surface having the same shape as one surface of the light guide.

22. A method comprising providing a curved object in a container, pouring a liquid into the container, solidifying the liquid and cutting the solid so formed in a shape of varying thickness, wherein at least one of the curved object and the liquid comprises light extracting features.
